(19) United States
(12) Patent Application Publication
(10) Pub. No.: US 2011/0087997 A1
(43) Pub. Date: Apr. 14, 2011

(54) LIST SCROLLING METHOD AND DEVICE ADAPTED TO THE SAME

(75) Inventors: Sang Hoon LEE, Daegu (KR); Jae Eik JUNG, Daegu (KR); Young Hae KIM, Yongin-si (KR)

(73) Assignee: SAMSUNG ELECTRONICS CO. LTD., Suwon-si (KR)

(21) Appl. No.: 12/902,674

(22) Filed: Oct. 12, 2010

(30) Foreign Application Priority Data
Oct. 14, 2009 (KR) 10-2009-0097577

(51) Int. Cl. G06F 3/048

(52) U.S. Cl. 715/830

(57) ABSTRACT

A list scrolling control method, system, and device are provided. When scrolling is controlled, the change in data is not displayed on the list area but scrolling information is provided via an information region additionally provided by the scroll bar, thereby quickly performing a list scrolling process. The list scrolling method includes detecting interaction for scroll control on a list screen, and displaying a scroll bar range, varied according to the detected interaction, on an area of a scroll bar.

### PRIORITY

This application claims the benefit under 35 U.S.C. §119(a) of a Korean patent application filed on Oct. 14, 2009 in the Korean Intellectual Property Office and assigned Serial No. 10-2009-0097577, the entire disclosure of which is hereby incorporated by reference.

### BACKGROUND OF THE INVENTION

1. Field of the Invention

The present invention relates to electronic systems. More particularly, the present invention relates to an apparatus and method for scrolling a list in a mobile device.

2. Description of the Related Art

Recently, with the development of electronic technology, mobile devices have provided a variety of functions. For example, the functions include a wireless Internet, a media data reproduction, a digital camera, and the like, or a combination thereof.

Conventional mobile devices have provided a variety of lists on their screen, for example, a data list, a menu list, a message list, and the like. The conventional mobile devices have been equipped with a memory in gigabytes to store a large amount of data items. In general, such a large amount of data items are arranged and stored in lists. That is, each list includes a number of data items which causes a mobile device user to have difficulty searching for a corresponding list and a data item in the list that requires more search time.

Conventional list search methods search a list for a corresponding data item in such a way that a cursor is shifted, one by one, on data items in the list by operating direction keys installed to the mobile devices. The conventional list search methods can also search lists for corresponding data items by controlling a slider of a scroll bar placed on one side of the list screen.

However, although the list search method using direction keys can perform a detailed search for a data item in the list, it is disadvantageous in that, if the list has a number of data items and includes many pages to be displayed on a list screen, the user has to repeatedly operate the direction keys in order to search for a data item. Thus, a lot of time is consumed in order to move to a corresponding list page.

The list search method via the slider control is disadvantageous in that movement of the slider causes a change in a range of the list displayed on the list screen. That is, although the list search method via the slider control can easily switch list pages by controlling the slider of the scroll bar, it is disadvantageous because, if the lists are scrolled at a high speed, the list pages cannot be switched smoothly therebetween. In this case, the list screen displays a list of data items that does not correspond to movement of a user's slider. That is, if the scroll speed of lists is large according to the quick movement of the slider, the lists displayed on the list screen are simultaneously required to move fast. However, this is impossible because of the limitation of the actual speed of the operation process. In addition, the slider cannot follow the user's scroll speed, according to the load due to the list operation process.

Therefore, a need exists for a list scrolling method and mobile device controlling a scroll in order to reduce the time for searching a list in a mobile device.

### SUMMARY OF THE INVENTION

An aspect of the present invention is to address the above-mentioned problems and/or disadvantages and to provide at least the advantages described below. Accordingly, an aspect of the present invention is to provide a list scroll method and a mobile device adapted thereto for controlling a scroll with respect to lists provided by the mobile device.

Another aspect of the present invention is to provide a list scroll method and a mobile device adapted thereto for quickly displaying a scroll bar range on a screen, corresponding to a user's scrolling speed, and for performing a scrolling process at the user's scrolling speed.

Still another aspect of the present invention is to provide a list scroll method and a mobile device adapted thereto for quickly providing a scroll bar range to an upper end and a lower end of a scroll bar when a list is scrolled.

A further aspect of the present invention is to provide a list scroll method and a mobile device adapted thereto for displaying a scroll bar range to an upper end and a lower end of a scroll bar and for quickly displaying a list screen of a corresponding scroll bar range when a scrolling operation is ended.

In accordance with an aspect of the present invention, a list scrolling method is provided. The method includes detecting interaction for scroll control on a list screen, and displaying a scroll bar range, varied according to the detected interaction, on a certain region of a scroll bar.

In accordance with another aspect of the present invention, a list scrolling method is provided. The method includes detecting interaction for scroll control on a list screen, displaying a scroll bar range, varied according to the detected interaction, on a certain region of a scroll bar, extracting, if the interaction is released, a data item corresponding to the scroll bar range, and displaying data items on the list screen, with respect to the extracted data item.

In accordance with another aspect of the present invention, a scroll system is provided. The system includes a slider, information regions, and a list region. The slider performs the control of a scroll for data items in the list region. The information regions show a scroll bar range corresponding to movement range of the slider. The list region fixes and displays data items when the interaction to control the scroll occurs. The list region displays data items altered corresponding to the scroll bar range when the interaction is released.

In accordance with another aspect of the present invention, a mobile device is provided. The device includes a display unit and a controller. The display unit displays a list screen according to a user's request. The display unit fixes and displays data items initially displayed in a list region when the scroll control is performed. The display unit updates and displays a scroll bar range varied according to the scroll control, in real time. The controller retains data items initially displayed on the list screen if the interaction to control the scroll is detected on the list screen. The controller updates and displays only the scroll bar range, in real time.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspect, features, and advantages of certain exemplary embodiments of the present invention will be more apparent from the following description taken in conjunction with the accompanying drawings, in which:

FIG. 1 is a flowchart describing a list scrolling control method of a mobile device according to an exemplary embodiment of the present invention;

FIG. 2 illustrates list screens displayed on a mobile device according to an exemplary embodiment of the present invention;

FIG. 3 illustrates list screens describing a list scroll operation of a mobile device according to an exemplary embodiment of the present invention;

FIG. 4 is a flowchart describing a method for scrolling a list according to an exemplary embodiment of the present invention; and

FIG. 5 is a schematic block diagram illustrating a mobile device according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Exemplary embodiments of the present invention provide a list of data items and a mobile device that provides the list on a screen. A list scrolling method and the mobile device adapted thereto may display information regarding a scroll bar range on an upper end and a lower end of the scroll bar of the list. When a user stops controlling a scrolling operation, the mobile device may quickly display a corresponding scroll bar range on a list screen.

The mobile device according to an exemplary embodiment of the present invention may update and display a scroll bar range, in real time, in the upper end and the lower end of the scroll bar when a scroll control event occurs on the list screen. In addition, the mobile device may display a list in a corresponding scroll bar range immediately when an occurrence of the scroll control event is stopped. The mobile device may quickly provide a scroll bar range on the list screen corresponding to a user's scrolling speed.

In the exemplary embodiments of the present invention, data includes all type of data recordable in the mobile device, for example, audio data, broadcast data, photo data, menu data, message data, video data, and the like. List screens refer to screens that may display the audio data, the broadcast data, the photo data, the menu data, the message data, the video data, and the like, which are called an audio data list screen, a broadcast data list screen, a photo data list screen, a menu data list screen, a message data list screen, a video data list screen, and the like, respectively. Although the exemplary embodiments of the present invention are described in such a way that the list screen displays a list of items arranged in a number of rows and one column, it should be understood that the present invention is not limited thereto. For example, the list screen may also display a list of items in the form of one row and a number of columns or a grid, i.e., a number of rows and columns.

Although the exemplary embodiments in such a way that the slider is controlled by a touch gesture applied to the touch screen, it should be understood that the exemplary embodiments of the present invention is not limited thereto. For example, the slider may also be controlled by various types of input modes, such as, an operation of direction keys, a voice recognition mode, a motion recognition mode, and the like.

In the exemplary embodiments of the present invention, the mobile device and the list scrolling control method and system adapted to the mobile device are described in detail below. It should be understood that the present invention is not limited thereto. For example, the exemplary embodiments of the present invention may be provided with various modifications.

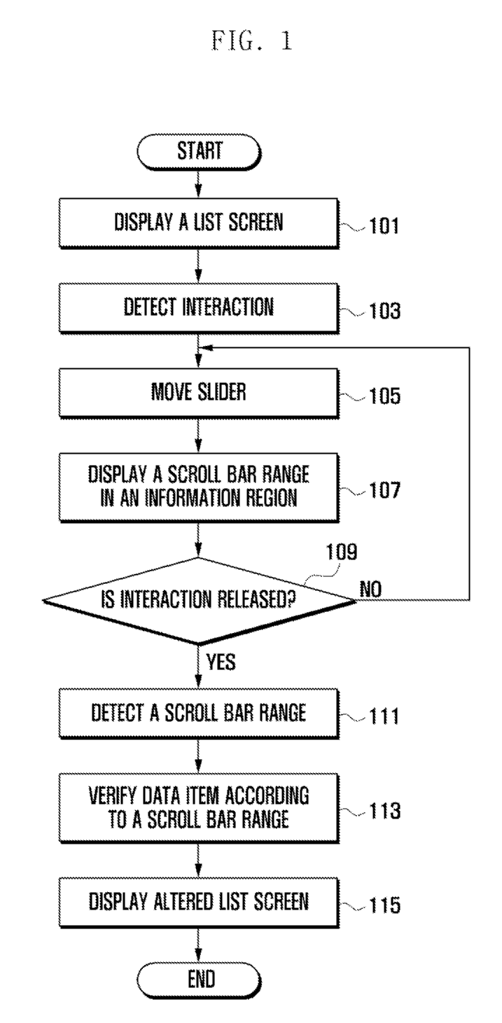

FIG. 1 is a flowchart describing a list scrolling control method of a mobile device according to an exemplary embodiment of the present invention.

Referring to FIG. 1, the mobile device displays a list screen according to a user's operation in step 101. The list screen refers to a screen on which a list of data items is displayed. The data items may be classified into categories, according to their types, for example, audio data items, video data items, broadcast data items, message data items, photo data items, and the like. The list has a certain number of data items that are classified into the same category. For example, if the mobile device classifies 100 audio data items into one music category and stores the audio data items, the list of 100 audio data items may be created in the music category.

After displaying the list screen in step 101, the mobile device detects an interaction on the touch screen input by the user in step 103. The interaction refers to an action where the user selects one of the data items in the list on the list screen, the user executes a particular function, such as playback of the selected data item, the user scrolls a list, and the like. An exemplary embodiment of the present invention is described based on an interaction for scrolling a list. More particularly, the interaction for scrolling the list may also control movement of a slider formed in the scroll bar. The interaction may be created by a touch signal, where the touch signal is generated when the user touches the slider. The interaction may also be created by a key signal, where the key signal is generated by operating keys for controlling the slider, for example, direction keys installed to one side of the mobile device.

The mobile device moves the slider according to the interaction in step 105. The mobile device displays a scroll bar range, varied according to the movement of the slider, in an information region of the scroll bar in step 107. The mobile device may reflect, in real time, the change in the scroll bar range corresponding to the movement of the slider, to the information region of the scroll bar and may display the scroll bar range on the screen. The scroll bar range is divided into an upper information range and a lower information range, which will be described in more detail below. The operation remains until the slider controlling interaction for controlling a list scroll is released.

Thereafter, the mobile device verifies whether the detected interaction is released in step 109. If the mobile device determines that the detected interaction is not released in step 109, the operation returns to step 105.

On the contrary, if the mobile device determines that the detected interaction is released in step 109, the mobile device detects the scroll bar range at a time point that the interaction is released in step 111. The scroll bar range may correspond to a value provided to the information region of the scroll bar at the time point that the interaction is released.

The mobile device verifies a data item at a location in the scroll bar range in step 113. The mobile device may verify at least one of the data items located at the top and the bottom in the scroll bar range. The data item located at the top on the list screen is hereinafter called a top data item. Likewise, the data item located at the bottom on the list screen is hereinafter called a bottom data item. The scroll bar range, displayed via the information region, includes upper range information and lower range information displayed at an upper end and a lower end of the scroll bar. The upper range information and the lower range information may be used to extract respective data items.

For example, if the upper information in the scroll bar range is ‘77’, the mobile device may conjecture the 77^{th} data item in the list. The mobile device may further conjecture all the data items, i.e., from the following 77^{th} data item to a data item corresponding to a preset reference value. The preset reference value may be the number of data items that may be displayed on the list screen. For example, if the preset reference value is ‘8’, the list screen may display 8 data items. The reference value may be set according to the size of the display unit of the mobile device or a user's selection.

Thereafter, the mobile device displays a list of verified data items corresponding to the reference value on the list screen in step 115. If the data items are verified in a mode for extracting the top data item, in step 113, the mobile device displays the extracted top data item at the top on the list screen and then simultaneously arranges and displays the remaining data items toward the bottom, in order, i.e., from a data item following the extracted top data item to a data item corresponding to the preset reference value. Likewise, if the data items are verified in a mode for extracting the bottom data item, in step 113, the mobile device displays the extracted bottom data item at the bottom on the list screen and then simultaneously arranges and displays the remaining data items toward the top on the list screen, in order, i.e., from a data item following the extracted bottom data item to a data item corresponding to the preset reference value.

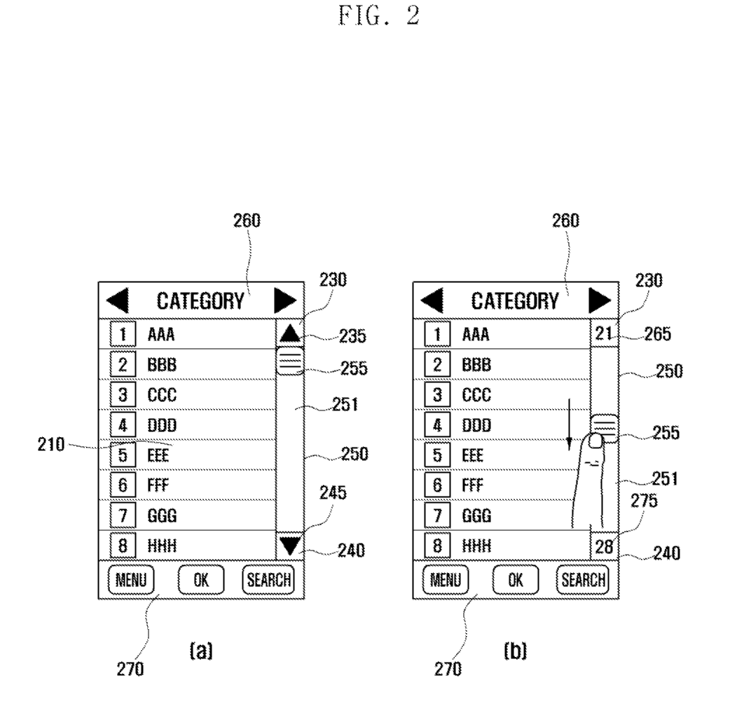

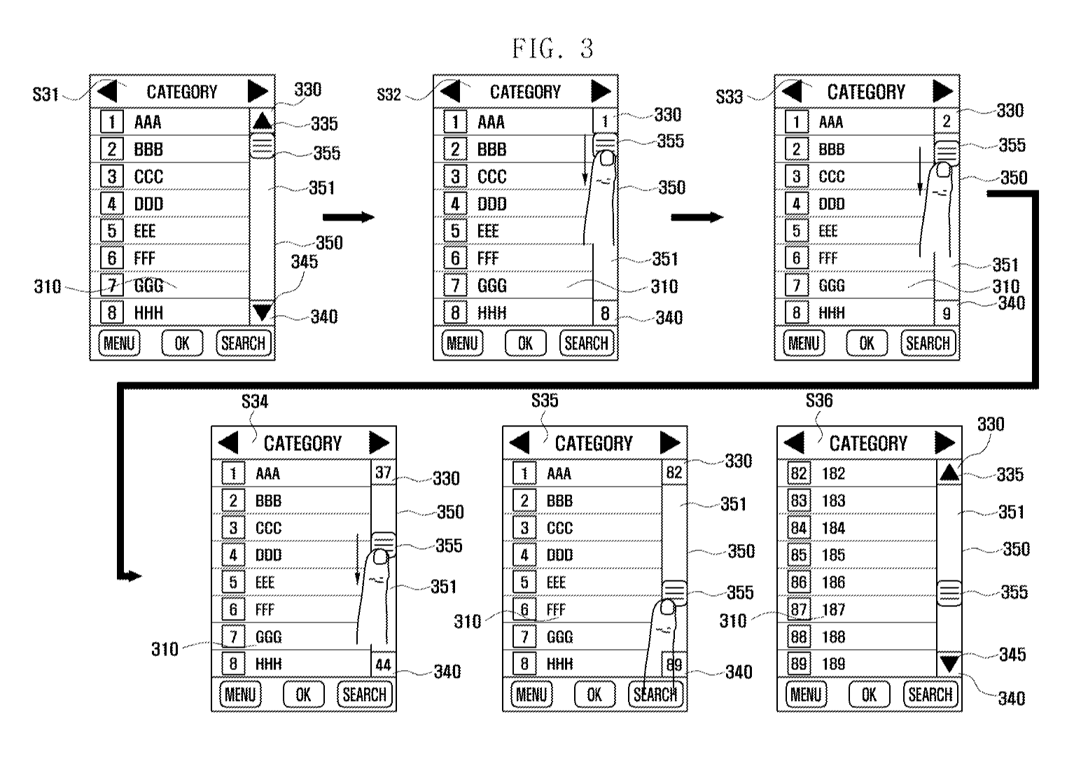

A method for configuring the list screen in the mobile device and a method for controlling the slider to scroll data items in the list on the list screen will be described in detail below with reference to FIGS. 2 and 3. It should be understood that the present invention is not limited thereto. For example, the exemplary embodiments of the present invention may be provided with various modifications.

FIG. 2 illustrates list screens displayed on a mobile device according to an exemplary embodiment of the present invention.

Referring to FIG. 2, diagram (a) illustrates a list screen illustrating an initial state or a state where a list scroll control event does not occur. Diagram (b) illustrates a list screen illustrating a state where a list scroll control event occurs. The list screen includes audio data, broadcast data, photo data, menu data, message data, video data, and the like. The list screen may display one of the listed data, in a user's selected category. Although an exemplary embodiment of the present invention is described in such a way that the list screen displays a list of items arranged in a number of rows and one column, it should be understood that the exemplary embodiment of the present invention is not limited thereto. For example, it should be understood that the list screen may also display a list of items in the form of one row and a number of columns or a grid, i.e., a number of rows and columns.

Referring to FIG. 2, the list screen includes a list region 210, a scroll bar 250, a category region 260 for illustrating a category containing the current list screen, and a submenu region 270 for setting options of data items in the list. The submenu region 270 may be omitted according to the type of mobile device. The submenu region 270 may also disappear according to a user's request.

The list region 210 arranges and displays data items, classified into a corresponding category, in a certain form, for example, a number of rows and one column. The scroll bar 250 includes a scroll region 251, a slider 255, and information regions 230 and 240. The information regions 230 and 240 are divided into an upper information region 230 and a lower information region 240. In an exemplary implementation, the scroll bar may include only one of the information regions according to the design.

More particularly, when a list scroll control interaction does not occur, indicators 235 and 245 for indicating the scroll direction may be displayed in the information regions 230 and 240 of the scroll bar 250. The indicators 235 and 245 have arrows to show directions, respectively. That is, the indicators 235 and 245 are divided into an upper indicator 235 for indicating an upward scroll direction and a lower indicator 245 for indicating a downward scroll direction. When the list scroll control interaction occurs according to the movement of the slider 255, range information 265 and 275 for showing the scroll bar ranges may be displayed in the information regions 230 and 240 of the scroll bar 250. That is, when the list scroll control interaction occurs, the information regions 230 and 240 provide range information 265 and 275 for showing variable scroll bar ranges, instead of the indicators 235 and 245.

The range information 265 and 275 are altered and displayed, in real time, according to the movement of the slider 255, or the list scroll control interaction. When the list scroll control interaction is released, the information regions 230 and 240 show the indicators 235 and 245 instead of showing the range information 265 and 275. The showing of the indicators will be described in more detail with reference to FIG. 3.

Although an exemplary embodiment of the present invention, as illustrated in diagrams (a) and (b) in FIG. 2, is described in such a way that the list screens display eight (8) data items, the list screen may be modified so that the list screen may display n data items, where n is an integer, according to the size of the display unit of the mobile device and the user's settings. In addition, the data items that disappeared to the top or bottom on the list screen may be displayed on the list screen by a scroll control operation using direction keys or by a scroll control event according to touch gestures, such as a drag, a flick, a move, and the like.

FIG. 3 illustrates list screens describing a list scroll operation of a mobile device according to an exemplary embodiment of the present invention.

Referring to FIG. 3, the list screen illustrates a list region 310, a scroll bar 350, a scroll region 351, a slider 355, information regions 330 and 340, and indicators 335 and 345.

Referring to FIG. 3, diagram S31 illustrates a list screen illustrating data items of a particular category according to a user's request. When the mobile device first displays the list screen, the information regions 330 and 340 may show indicators 335 and 345. The indicators 335 and 345 are divided into an upper indicator 335 for indicating an upward scroll direction and a lower indicator 345 for indicating a downward scroll direction.

The user performs an interaction with the slider 355 of the scroll bar 350 on the list screen as illustrated in diagram S32 and controls the list scroll. The interaction may be created by a touch signal corresponding to the user's touch gesture. When the mobile device detects the user's interaction, the mobile device removes the indicators 335 and 345 from the information regions 330 and 340 and instead displays range information for showing scroll bar ranges. During this process, the slider 355 appears and stays at the first location where it appeared without moving the interaction.

In this case, range information regarding the highest order of one of the data items in the list and the order of a data item corresponding to the preset reference value (e.g., 8) is provided to the information regions 330 and 340, respectively. Therefore, as illustrated in diagram S32, the upper information region 330 shows the range information ‘1’, corresponding to the order (1) of the highest data item, i.e., the first data item AAA. Likewise, the lower information region 340 shows the range information ‘8’, corresponding to the order (8) of the 8th data item HHH, counted from the first data item AAA.

As illustrated in diagrams S33, S34, and S35, the user moves the slider 355 by his/her interaction. That is, the user may perform a list scroll operation by moving the slider 355. In this case, the mobile device may update and show, in real time, range information in the information regions 330 and 340, according to the movement of the slider 355.

For example, as illustrated in diagram S33, the mobile device determines the movement range of the slider 355, extracts range information corresponding to the determined movement range, and shows the extracted range information, for example, ‘2’, in the upper range region 330. Simultaneously, the mobile device shows range information ‘9’, considering the reference value 8, in the lower information region 340. The method for determining range information to be shown in the information regions 330 and 340 will be described in more detail below.

In addition, as illustrated in diagram S34, the mobile device determines the upper range information ‘37’ and the lower range information ‘44’ according to the movement range of the slider 355 and displays the upper range information ‘37’ and the lower range information ‘44’ in the upper information region 330 and the lower information region 340, respectively. Likewise, as illustrated in diagram S35, the mobile device determines the upper range information ‘82’ and the lower range information ‘89’ according to the movement range of the slider 355 and displays the upper range information ‘82’ and the lower range information ‘89’ in the upper information region 330 and the lower information region 340, respectively.

If the user selected a scroll bar range (e.g., the order range corresponding to the 82nd˜89th data items) containing a desired data item as shown in diagram S35, the user may release the interaction from the slider 355 as illustrated in diagram S36. That is, the user does not apply a touch action to the slider 355. In this case, the mobile device does not receive a touch signal and thus concludes that the interaction has been released.

When the interaction has been released as illustrated in diagram S36, the mobile device refers to the range information ‘82’ of the upper information region 330 and/or the range information ‘89’ of the lower information region 340, extracts a data item of a corresponding order, and arranges and displays data items with respect to the extracted data item on the list screen. That is, the mobile device removes data items from ‘AAA’ to ‘HHH’ from the list region 310 illustrated in diagram S35, and instead displays data items from ‘182’ corresponding to the upper range information ‘82’ to ‘189’ corresponding to the lower range information ‘89’ as illustrated in S36. Simultaneously, the mobile device replaces the range information with indicators 335 and 345 in the information regions 330 and 340.

As described above, the mobile device according to an exemplary embodiment of the present invention may allow a user to control a list scroll via the range information, without altering data items on the list region, during the interaction to control the slider 355. When the interaction to control the slider 355 is released at a time point, during the list scrolling operation, the mobile device extracts the range information regarding the location of the slider 355 and data items corresponding to the range information at the time point, and then arranges and displays the extracted data items, in order, on the list screen. Simultaneously, the mobile device may display the indicators 335 and 345 on the information regions 330 and 340, instead of displaying the range information, at the time point that the interaction is released.

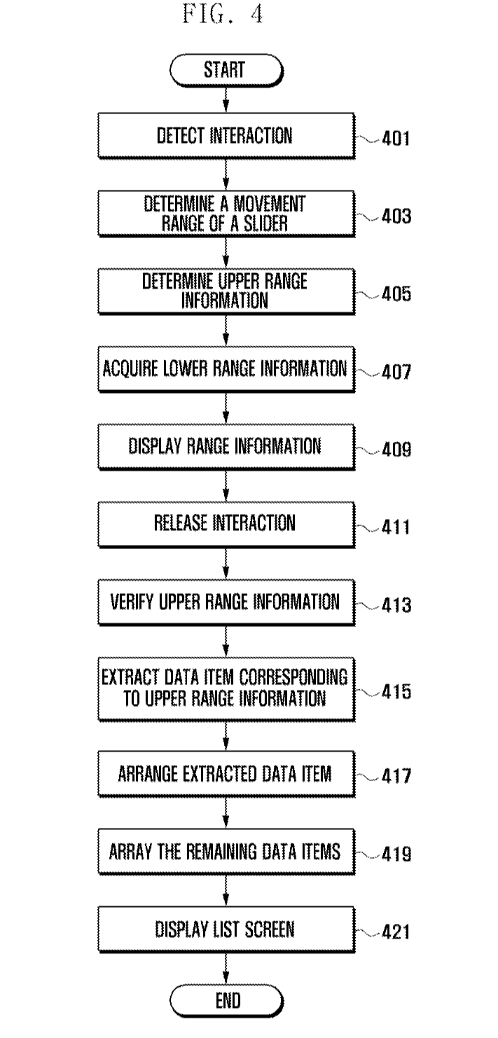

A list scroll control system of the mobile device and a configuring method of list screens according to the scroll control have been described above. Also, an operation for adaptively altering and displaying information in the information regions of the scroll bar has also been described. Determination of range information provided to the information regions, extraction of data items corresponding to the determined range information, and arrangement of the extracted data items corresponding to a reference value will be described with reference to FIG. 4.

FIG. 4 is a flowchart describing a method for scrolling a list according to an exemplary embodiment of the present invention.

Referring to FIG. 4, the mobile device displays a list screen and detects an interaction that occurs in the slider in step 401. The mobile device determines a range of movement of the slider according to the interaction in step 403. The method for determining the movement range of a slider is well-known in the art of list scroll technology, and thus a detailed description of the determined movement range will be omitted.

The mobile device determines range information corresponding to the movement range of the slider in step 405. The range information may be at least one of upper range information and lower range information according to settings. In an exemplary implementation, it is assumed that the mobile device determines the upper range information and then acquires the lower range information by applying a preset reference value to the upper range information. The upper range information may be determined based on the determined movement range of the slider. That is, the upper range information is provided as a number corresponding to the movement range, so that the user may easily recognize the movement range. The range information may be the same number as the order of the data item located at the highest location in the movement range of the slider.

Thereafter, the mobile device acquires the lower range information using the determined upper range information in step 407. The lower range information may be acquired by adding the reference value to the upper range information. The reference value is the number of data items to be displayed on the list screen. The reference value may be determined according to the screen size of the mobile device when the mobile device is manufactured or be set by a user's settings. For example, if the reference value is ‘8’, the list screen may display 8 data items at once.

The mobile device displays the upper range information and the lower range information on the information region on the list screen in step 409. The upper range information and the lower range information may be displayed on an upper information region and a lower information region, respectively. If there is no change in the data items in the list region, the mobile device displays the screen data that was provided at the time point that the list scroll control is performed according to the movement of the slider.

The mobile device detects the interaction release while the list scroll control is performed according to the movement of slider in step 411. The interaction release may be a case where a touch action is not applied to the slider.

When detecting the interaction release in step 411, the mobile device verifies the upper range information that is determined at the location of the slider at the time point that the interaction is released in step 413. The mobile device extracts a data item having identification information corresponding to the upper range information, or the order corresponding to the upper range information in step 415. For example, if the upper range information is ‘8’, the mobile device extracts a data item having the 8th data item in the list. Likewise, if the upper range information is ‘77’, the mobile device extracts a data item having the 77th data item in the list.

Thereafter, the mobile device arranges the extracted data item in the top on the list screen in step 417. The mobile device arranges the remaining data items at the second and the following locations, in order, from the top of the list screen in step 419. The remaining data items may be arranged on the list screen so that the total number of data items corresponds to the reference value. That is, the number of data items displayed on the list screen is identical to the reference value. For example, if the upper range information is ‘8’ and the reference value is ‘8’, the list screen may arrange the 8^{th} data item at the top of the list screen and then the remaining 7 data items, i.e., 9^{th}, 10^{th}, 11^{th}, 12^{th}, 13^{th}, 14^{th} and 15^{th} data items, at the locations, in order, from the top. Also, if the upper range information is ‘77’ and the reference value is ‘5’, the list screen may arrange the 77^{th} data item at the top of the list screen and then the remaining 4 data items, i.e., 78^{th}, 79^{th}, 80^{th}, and 81^{st} data items, at the locations, in order, from the top.

After arranging the data items as described in steps 417 and 419, the mobile device displays the list of data items on the list screen in step 421.

A method for extracting the top data item based on the upper range information, for arranging the remaining data items at the locations, toward the bottom, from the location of the extracted top data item, considering the reference value, and for displaying the list of data items on the list screen has been described above. Although an exemplary embodiment of the present invention has been described based on an arrangement with respect to the top data item, it should be understood that the bottom data item may be extracted based on the lower range information, the remaining data items may be arranged at the locations, toward the top, from the location of the extracted bottom data item, considering the reference value, and the list of data items may be displayed on the list screen.

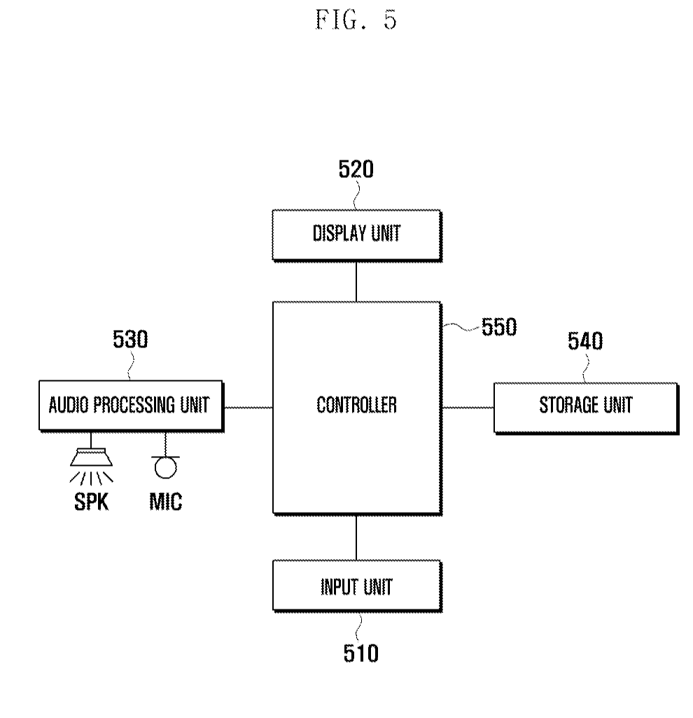

A configuration of the mobile device according to an exemplary embodiment of the present invention will be described below with reference to FIG. 5. It should be understood that the present invention is not limited thereto. For example, the exemplary embodiments of the present invention may be provided with various modifications.

FIG. 5 is a schematic block diagram illustrating a mobile device according to an exemplary embodiment of the present invention.

Referring to FIG. 5, the mobile device includes an input unit 510, a display unit 520, an audio processing unit 530, a storage unit 540, and a controller 550.

The input unit 510 creates input signals corresponding to number and letter information and signals for setting and controlling a variety of functions of the mobile device, and outputs them to the controller 550. The input unit 510 includes keys and function keys for allowing a user to input and set information and functions. The function keys include direction keys, side keys, shortcut keys, and the like, which are set to perform specific functions. The input unit 510 may be implemented with, according to the type of mobile device, one of a touch pad, a touch screen, a keypad of a general key arrangement, or a QWERTY keypad, or a combination thereof. More particularly, the input unit 510 creates an input signal for list scroll control on a list screen, on which a list of data items is displayed, and outputs the input signal to the controller 550. The input signal for list scroll control may be a key signal according to an operation of direction keys or a touch signal according to a user's touch gesture applied to the touch screen.

The display unit 520 illustrates a variety of screens when the mobile device executes corresponding functions, for example, a boot screen, an idle screen, a menu screen, a list screen, a playback screen, and the like. That is, the display unit 520 may display various screens related to states and functions of the mobile device. The display unit 520 may be implemented with a Liquid Crystal Display (LCD), an Organic Light Emitting Diode (OLED), and the like. More particularly, if the display unit 520 is implemented with a touch screen, the display unit 520 may also serve as an input device.

When the display unit 520 implemented with a touch screen displays a list screen to perform an input function, the slider of the scroll bar may be controlled on the list screen according to a user's touch gesture. That is, the user applies a touch action to a region of the slider on the display unit 520 and thus controls the slider and the list scroll. The display unit 520 may display a list region and a scroll bar region on the list screen. The scroll bar region includes an upper information region and a lower information region, a scroll region, and a slider. The display unit 520 may show an upper indicator and a lower indicator in the upper information region and the lower information region, respectively, or the upper information region and the lower information region therein, respectively, according to the control of the controller 550.

While the slider which controls the list scroll is being moved, the display unit 520 may show range information, varied in real time, on the information regions, and also may retain and display data items in the list region on the list screen without changing its state. If the list scroll control is released, the display unit 520 shows the indicators in the information region and simultaneously switches the current data items to data items corresponding to the control of the controller 550 in the list region on the list screen.

The audio processing unit 530 includes a Speaker (SPK) for reproducing audio signals and a Microphone (MIC) for receiving audio signals, such as a user's voice, and the like. The audio processing unit 530 receives audio signals via the MIC and outputs audio data to the controller 550. The audio processing unit 530 converts analog audio signals from the microphone MIC into digital audio signals and outputs the digital audio signals to the controller 550. The audio processing unit 530 also converts the digital audio signals from the controller 550 into analog audio signals and outputs the analog audio signals via the SPK. In an exemplary implementation, the audio processing unit 530 may output various audio signals generated by the mobile device to the SPK, according to a user's selection. The mobile device may create sound effects when reproducing data or performing the list scrolling operation.

The storage unit 540 may include a Read Only Memory (ROM) and a Random Access Memory (RAM). The storage unit 540 stores data created and used in the mobile device. The data may be generated when the mobile device is operated, for example, audio data, video data, broadcast data, photo data, message data, and the like. The data may also be all types of data that is created by the mobile device or is downloaded from external systems, a web server, an external device, a personal computer, and the like. The data may further be applications for directly executing corresponding functions/menus in the mobile device. The storage unit 540 may store software related to the list scroll control and options for the functions of the mobile device, for example, a reference value, a mode for displaying range information, and the like.

The storage unit 540 includes at least one buffer for temporarily storing data generated when the mobile device executes the functions. For example, the storage unit 540 may buffer various types of data (i.e., operation values, and the like) by a preset size of buffer during the list scroll. The storage unit 540 may also be implemented with all types of recording media that may be installed inside or outside the mobile device, for example, a smart card. The storage unit 540 may include a RAM, a ROM, or a flash memory, or a combination thereof. The storage unit 540 may include one or two integrated memory units, for example, Multi-Chip Package (MCP) memory, and the like.

The controller 550 controls the entire operation of the mobile device and the signal flow among the elements in the mobile device. For example, the elements may be the input unit 510, the display unit 520, the audio processing unit 530, and the storage unit 540.

The controller 550 distinguishes a list region and scroll bar when configuring the list screen. The controller 550 also divides the scroll bar region into a scroll region, information regions, and a slider. The controller 550 arranges data items, contained in a corresponding category, in the list region, according to a preset order. The controller 550 also controls the list scroll according to the movement of the slider of the scroll bar. The scroll bar moves the slider according to an interaction, determines the range of movement of the slider, and control the output of the range information regarding the information regions. The information regions may replace the indicators of the scroll bar with the range information corresponding to the movement of the slider and displays the range information on the list screen, when controlling the list scroll.

When the interaction to control the movement of the slider continues occurring, the controller 550 updates and displays the range information in the information regions, in real time. If the occurrence of the interaction is stopped at a particular location, the controller 550 stops the change in the range information corresponding to the movement range of the slider and displays the information in the information regions.

When the controller 550 detects that the interaction to control the movement of the slider is released, the controller 550 detects the range information according to the movement range of the slider at the time point that the interaction has been released. Thereafter, the controller 550 extracts a data item having an order corresponding to the range information. The controller 550 may extract a data item of an order corresponding to the upper and/or the lower range information, according to the options.

When the controller 550 extracts a data item of an order corresponding to the upper range information, the controller 550 may arrange the extracted data item at the top of the list screen and then the remaining data items at the second and following locations from the top, toward the bottom, in order, and may display the list of data items on the list screen. On the contrary, if the controller 550 extracts a data item of an order corresponding to the lower range information, the controller 550 may arrange and display the extracted data item at the bottom of the list screen and then the remaining data items at the second and following locations from the bottom, toward the top, in order, and may display the list of data items on the list screen. As such, if a data item is selected based on the upper range information, data items prior to the order of the top data item may be arranged before the extracted data item. However, the data items prior to the order of the top data item are not displayed on the list screen. Likewise, if a data item is selected based on the lower range information, data items following the order of the top data item may be arranged after the extracted data item. However, the data items following the order of the top data item are not displayed on the list screen.

The control functions of the controller 550 may be implemented with software. In this case, the software may also control an entire function of the mobile device as described with reference to FIGS. 1 to 5.

Although the configuration of the mobile device according to an exemplary embodiment of the present invention is illustrated in FIG. 5, it should be understood that the present invention is not limited thereto.

For example, the mobile device may further include a baseband module for providing a mobile communication service. The mobile device also includes a Radio Frequency (RF) communication unit. The baseband module may be installed to the controller 550 and the RF communication unit, respectively or separately.

Although it is not illustrated in FIG. 5, the mobile device may further include a short range communication module for performing short-range communication, a camera module for capturing images or moving images, an interface unit for transmitting and receiving data in a wired or wireless mode, an internet communication module for performing an Internet function, a digital broadcast receiver module for receiving and reproducing broadcasts, and the like.

With a convergence of digital devices, there may be many digital devices and modifications thereof, not listed in the application. It will be understood that the digital devices and modifications may also be included in the mobile device. Also, according to the mobile device purpose, the mobile device may be implemented by omitting a particular element or replacing the particular element with other elements.

As described above, according to the scroll control system of an exemplary embodiment of the present invention, the list screen includes a list region and a scroll bar. The scroll bar region includes a slider for scrolling data items in the list region and information regions for showing a scroll bar range corresponding to the movement range of the slider. The list region fixes and displays data items when the interaction for the scroll control occurs, and displays data items altered corresponding to the scroll bar range when the interaction is released.

According to the scroll control, the mobile device includes a display unit and a controller. The display unit displays a list screen according to a user's request. The display unit fixes and displays the data items initially displayed in the list region when the scroll control is performed. The display unit updates and displays the scroll bar range varied according to the scroll control. When the controller detects the interaction to control the scroll on the list screen, the controller continues to display the data items initially displayed on the list screen, and updates and displays only the scroll bar range. In an exemplary implementation, the display unit is implemented with a touch screen, so that the user may perform the scroll control on the touch screen with a touch gesture.

The information regions according to an exemplary embodiment of the present invention are divided into the upper information region for providing range information regarding the top data item in the scroll bar range and the lower information region for providing range information regarding the bottom data item. The information regions display the indicators when the interaction does not occur or the occurred interaction is released, and replace the indicators with the range information when the interaction occurs. More particularly, the information regions alter and update the scroll bar range according to the movement range of the slider, in real time.

The controller displays the scroll bar range on both the upper information region and the lower information region of the scroll bar. The controller switches a current list screen to a list screen that displays data items of a scroll bar range varied when the interaction is released.

The controller determines range information corresponding to the scroll bar range and displays the range information in at least one of the upper information region and the lower information region of the scroll bar. More particularly, the controller determines the upper range information corresponding to the scroll bar range, acquires the lower range information using the upper range information and a preset reference value, and displays the upper range information and the lower range information at corresponding regions of the scroll bar.

As described above, according to the scroll control method of an exemplary embodiment of the present invention, when the interaction to control the scroll control is detected on the list screen, the scroll bar range, varied according to the interaction, may be displayed on a certain region of the scroll bar. In addition, when the occurred interaction is released, a data item corresponding to the scroll bar range is extracted and the remaining data items are arranged on the list screen with respect to the extracted data item. In an exemplary implementation, when the interaction occurs, the data items initially displayed on the list screen are not altered, but only the scroll bar range is updated and displayed in real time. On the contrary, if the occurred interaction is released, the data items, initially fixed and displayed on the list screen, are replaced with those contained in the scroll bar range at the time that the interaction is released, and the altered data items are displayed on the list screen.

In order to display the scroll bar range on the information regions, the range information corresponding to the scroll bar range is determined and displayed on at least one of the upper information region and the lower information region of the scroll bar. More specifically, when the upper range information corresponding to the scroll bar range is determined, the lower range information is acquired using the upper range information and a preset reference value. The determined upper range information is displayed on the upper information region of the scroll bar. The acquired lower range information is also displayed on the lower information region of the scroll bar.

When the interaction is released, the top data item or the bottom data item may be selected according to one of the upper range information and the lower range information, corresponding to a set mode. More particularly, the selected top or bottom data item is arranged at a certain region of the list screen. The remaining data items are arranged at the locations, in order, with respect to the selected data item, so that the total number of data items is identical to the reference value. Thereafter, the selected data item and the remaining data items, arranged with respect to the selected data item, are displayed on the list screen. For example, if the top data item has been selected, the top data item is arranged and displayed at the top of the list screen and the remaining data items are arranged and displayed at the locations, in order, toward the bottom, from the top, so that the total number of data items is identical to the reference value. Likewise, if the bottom data item has been selected, the bottom data item is arranged and displayed at the bottom of the list screen and the remaining data items are arranged and displayed at the locations, in order, toward the top, from the bottom, so that the total number of data items is identical to the reference value.

It will be understood that the mobile device according to the exemplary embodiments of the present invention include all types of devices supporting the list scroll control. For example, the mobile device may be applied to all information communication devices, multimedia devices, and their applications, such as, mobile communication terminals supporting various types of communication protocols, a Personal Digital Assistant (PDA), a Portable Multimedia Player (PMP), a Moving Picture Experts Group (MPEG) audio layer-3 (MP3) player, a smart phone, a mobile game player, a personal computer, a laptop computer, a handheld Personal Computer (PC), and the like.

Although the list scroll control method and the mobile device adapted thereto, according to the exemplary embodiments of the present invention, have been described based on the list of data items, the list scroll control method and the mobile device may also be applied to a page scroll control method where a viewer screen may be switched with another when a particular application is executed. For example, if a viewer screen for a particular document is provided when a document view application is executed, the controller provides a scrolled page number to an information region in a state where a page displayed on the current viewer screen is fixed according to the page scroll control of the user who requests a switching operation between pages in the document. If the page scroll control is released, a control operation is performed so that the page corresponding to the page number may be switched.

As described above, the mobile device according to the exemplary embodiments of the present invention is equipped with a touch screen and the interaction is applied thereto in order to perform the list scroll control. The interaction occurs on the slider of the scroll bar and includes a touch, a drag, a flick, a move, and the like. However, the present invention is not limited thereto. It should be understood that the exemplary embodiments of the present invention may also be applied to devices without a touch screen. If the devices are not equipped with a touch screen but include keys/direction keys, the interaction for the list scroll control may be created by operating the keys/direction keys.

The mobile device according to the exemplary embodiments of the present invention may perform the list scroll control function via the MIC or a motion sensor. That is, the mobile device may control the movement of the slider, corresponding to commands for moving the slider, starting or stopping the list scroll control, and the like, by the voice recognition function or a motion recognition function. For example, when the mobile device displays a list of data items on the screen, the user may say “Start the lower scroll” or tilts the mobile device toward a ‘lower direction’, thereby achieving the list scroll control. The scroll command may correspond to the interaction input. According to the user's scroll command, the mobile device fixes and displays the data items in the list region on the list screen and updates and displays the range information regarding the information regions with respect to the scroll bar range, in real time. On contrary, if the user may say “Stop the scroll” or stops tilting the mobile device toward the ‘lower direction’ during the scroll operation, a command for stopping the list scroll may be achieved. The scroll stop command may correspond to the interaction release. According to the user's scroll stop command, the mobile device updates and displays the data items in the list region with the data items of the scroll bar range corresponding to the range information in the information regions.

As described above, the list scroll method and the mobile device adapted thereto, according to the exemplary embodiments of the present invention, may quickly display the scroll bar range at the upper end and the lower end of the scroll bar when the slider of the scroll bar is scrolled. When the controlling of the slider is stopped, a corresponding scroll bar range may be immediately displayed on the list screen. Therefore, although the mobile device user rapidly scrolls the list of items on the screen, the list scroll method and the mobile device adapted thereto may rapidly and precisely display the user's requested scroll bar range on the list screen.

The above-described methods according to the present invention can be implemented in hardware or as software or computer code that can be stored in a recording medium such as a Compact Disc (CD) ROM, an RAM, a floppy disk, a hard disk, or a magneto-optical disk or downloaded over a network, so that the methods described herein can be rendered in such software using a general purpose computer, or a special processor or in programmable or dedicated hardware, such as an Application Specific Integrated Circuit (ASIC) or a Field Programmable Gate Array (FPGA). As would be understood in the art, the computer, the processor or the programmable hardware include memory components, e.g., a RAM, a ROM, a Flash, and the like. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

While the invention has been show and described with reference to certain exemplary embodiments thereof, it will be understood by those skilled in the art that various changes in form and details may be made therein without departing from the spirit and scope of the invention as defined in the appended claims and their equivalents.

What is claimed is:

1. A list scrolling method, the method comprising:
detecting interaction for scroll control on a list screen; and
displaying a scroll bar range, varied according to the detected interaction, on a certain region of a scroll bar.

2. The method of claim 1, further comprising:
extracting, if the interaction is released, a data item corresponding to the scroll bar range; and
displaying data items on the list screen, with respect to the extracted data item.

3. The method of claim 2, wherein the displaying of the data items on the list comprises:
retaining, if the interaction occurs, data items initially displayed on the list screen, and updating and displaying only the scroll bar range, in real time.

4. The method of claim 3, wherein the displaying of the data items on the list comprises:
altering, if the interaction is released, the data items, initially fixed and displayed on the list screen, to data items included in a scroll bar range at a time point that the interaction is released; and
displaying the altered data items on the list screen.

5. The method of claim 3, wherein the displaying of the data items on the list comprises:
altering and displaying, if the interaction occurs, indicators provided to information regions of the scroll bar to range information corresponding to the scroll bar range.

6. The method of claim 5, further comprising:
altering and displaying, if the interaction is released, range information corresponding to a time point that the interaction is released to the indicators.

7. The method of claim 5, wherein the displaying of the data items on the list comprises:
determining range information corresponding to the scroll bar range; and
displaying the determined range information on at least one of an upper information region and a lower information region of the scroll bar.

8. The method of claim 7, wherein the range information on the lower information region is acquired by the range information on the upper information region and a preset reference value.

9. The method of claim 7, further comprising:
selecting, if the interaction is released, at least one of a top data item and a bottom data item according to one of the upper range information and the lower range information, corresponding to a setting mode.

10. The method of claim 9, further comprising:
arranging, when the at least one of the top data item and the bottom data item is selected, the selected data item at a certain region of the list screen;
arranging the remaining data items at the locations with respect to the selected data item, in order, so that a total number of data items is identical to a preset reference value; and
displaying the selected data item and the remaining data items arranged with respect to the selected data item on the list screen.

11. A mobile device, the device comprising:
a display unit for displaying a list screen according to a user's request, for fixing and displaying data items initially displayed in a list region when control of a scroll is performed, and for updating and displaying a scroll bar range varied according to the scroll control, in real time; and
a controller for retaining, if interaction to control the scroll is detected on the list screen, data items initially displayed on the list screen, and for updating and displaying only the scroll bar range, in real time.

12. The device of claim 11, wherein the controller extracts, if the interaction is released, a data item corresponding to the scroll bar range.

13. The device of claim 11, where the display unit retains, if the interaction occurs, data items initially displayed on the list screen.

14. The device of claim 11, wherein the controller divides the scroll bar range into an upper information region and a lower information region of the scroll bar, and displays a list screen varied with data items of the scroll bar range varied when the interaction is released.

15. The device of claim 14, wherein the controller alters and displays indicators provided to information regions of the scroll bar to range information corresponding to the scroll bar range if the interaction is detected, and range information corresponding to a time point that the interaction is released to the indicators if the interaction is released.

16. The device of claim 15, wherein the controller determines range information corresponding to the scroll bar range, and displays the determined range information on at least one of the upper information region and the lower information region of the scroll bar.

17. The device of claim 16, wherein the range information on the lower information region is acquired by the range information on the upper information region and a preset reference value

18. The device of claim 17, wherein the controller selects at least one of a top data item and a bottom data item according to one of the upper range information and the lower range information, corresponding to a setting mode, if the interaction is released, and arranges the remaining data items at locations with respect to the selected data item, in order, so that the total number of data items is identical to the reference value.
